(19) United States
(12) Patent Application Publication
(10) Pub. No.: US 2026/0124546 A1
(43) Pub. Date: May 7, 2026

(54) PROGRAM, INFORMATION PROCESSING SYSTEM, AND INFORMATION PROCESSING METHOD

(71) Applicant: CYGAMES, INC., Tokyo (JP)

(72) Inventors: Chika Soga, Tokyo (JP); Masashi Kachi, Tokyo (JP); Dai Kikuchi, Tokyo (JP)

(73) Assignee: CYGAMES, INC., Tokyo (JP)

(21) Appl. No.: 19/441,203

(22) Filed: Jan. 6, 2026

Related U.S. Application Data
(63) Continuation of application No. PCT/JP2024/025782, filed on Jul. 18, 2024.

(30) Foreign Application Priority Data
Jul. 28, 2023 (JP) 2023-123055

(51) Int. Cl. A63F 13/67

(52) U.S. Cl. CPC A63F 13/67

(57) ABSTRACT

Provided are a program, an information processing system, and an information processing method for improving the convenience of a recruitment activity related to an in-game community. A circle card image including information of a circle can be edited, post data available to be posted to an external service is created, and the post data is created on the basis of an SNS share operation of a player, the post data including the circle card image linked to the circle to which the player is affiliated, and link information used to make a participation application to the circle.

### CROSS-REFERENCE TO RELATED APPLICATIONS

This application is a continuation of International Patent Application No. PCT/JP2024/025782, having an international filing date of Jul. 18, 2024, which designated the United States, the entirety of which is incorporated herein by reference. Japanese Patent Application No. 2023-123055 filed on Jul. 28, 2023 is also incorporated herein by reference in its entirety.

### BACKGROUND OF THE INVENTION

The present invention relates to a program, an information processing system, and an information processing method for a game in which there is an in-game community in which a player can participate.

In the related art, there are known games in which players can establish in-game communities such as a guild, a clan, and a circle, and a player participates in a desired in-game community, thereby making it possible to interact with players affiliated to the same in-game community and to perform competitive play or cooperative play with the players affiliated to the same in-game community (See Publication of Japanese Patent No. 7203002).

Incidentally, even if a recruitment activity for recruiting players is performed in a game in order to increase the number of players affiliated to an in-game community, it is not uncommon that new players affiliated thereto cannot be secured. Thus, in recent years, there are cases where a recruitment activity for other players who enjoy the same game is performed by posting, to an external service such as a social networking service (SNS), a message indicating that the in-game community is recruiting.

### SUMMARY OF THE INVENTION

The present invention has been made in view of the above-described circumstances, and an object thereof is to provide a program, an information processing system, and an information processing method for improving the convenience of a recruitment activity related to an in-game community.

According to a first aspect of the invention, there is provided a program for a game in which there is an in-game community in which a player can participate, the program causing a computer to function as:
a profile image editing unit that enables editing of a profile image including information of the in-game community; and
a post data creating unit that creates post data available to be posted to an external service,
wherein the post data creating unit creates, on the basis of a specific operation of a player, the post data including the profile image, which is linked to the in-game community to which the player is affiliated, and link information used to make a participation application to the in-game community.

According to a second aspect of the invention, there is provided an information processing system for a game in which there is an in-game community in which a player can participate, the information processing system comprising:
a profile image editing unit that enables editing of a profile image including information of the in-game community; and
a post data creating unit that creates post data available to be posted to an external service,
wherein the post data creating unit creates, on the basis of a specific operation of a player, the post data including the profile image, which is linked to the in-game community to which the player is affiliated, and link information used to make a participation application to the in-game community.

According to a third aspect of the invention, there is provided an information processing method for a game in which there is an in-game community in which a player can participate, the information processing method causing a computer to execute:
a profile image editing step of enabling editing of a profile image including information of the in-game community; and
a post data creating step of creating post data available to be posted to an external service,
wherein, in the post data creating step, the post data is created on the basis of a specific operation of a player, the post data including the profile image, which is linked to the in-game community to which the player is affiliated, and link information used to make a participation application to the in-game community.

### BRIEF DESCRIPTION OF DRAWINGS

FIG. 1 is a view showing a hardware configuration of an information processing system.

FIG. 2 is a functional block diagram of a server in the information processing system.

FIG. 3 is a functional block diagram of a player terminal in the information processing system.

FIG. 4 is a view showing one example of a circle search screen displayed on the player terminal.

FIG. 5 is a flowchart showing the flow of processing leading to creation of post data.

FIG. 6 is a view showing one example of a circle home screen displayed on the player terminal.

FIGS. 7A-7B show views showing examples of a circle menu dialog displayed on the player terminal.

FIG. 8 is a view showing one example of a circle card screen displayed on the player terminal.

FIG. 9 is a view showing one example of a card edit screen displayed on the player terminal.

FIG. 10 is a view showing one example of a post screen with respect to an external service, displayed on the player terminal.

FIG. 11 is a view showing one example of a participation-application dialog displayed on the player terminal.

FIGS. 12A, 12B, 12C, 12D, and 12E show views showing examples of an alert dialog displayed on the player terminal.

### DETAILED DESCRIPTION OF THE INVENTION

(1) The present embodiment relates to a program for a game in which there is an in-game community in which a player can participate, the program causing a computer to function as: a profile image editing unit that enables editing of a profile image including information of the in-game community; and a post data creating unit that creates post data available to be posted to an external service, wherein the post data creating unit creates, on the basis of a specific operation of a player, the post data including the profile image, which is linked to the in-game community to which the player is affiliated, and link information used to make a participation application to the in-game community.
(2) In the program of the present embodiment, a member attribute is set for each player who is affiliated to the in-game community; and the profile image editing unit can give a right to edit the profile image to a player of which the member attribute is set to a leader.
(3) The present embodiment relates to an information processing system for a game in which there is an in-game community in which a player can participate, the information processing system including: a profile image editing unit that enables editing of a profile image including information of the in-game community; and a post data creating unit that creates post data available to be posted to an external service, wherein the post data creating unit creates, on the basis of a specific operation of a player, the post data including the profile image, which is linked to the in-game community to which the player is affiliated, and link information used to make a participation application to the in-game community.
(4) The present embodiment relates to an information processing method for a game in which there is an in-game community in which a player can participate, the information processing method causing a computer to execute: a profile image editing step of enabling editing of a profile image including information of the in-game community; and a post data creating step of creating post data available to be posted to an external service, wherein, in the post data creating step, the post data is created on the basis of a specific operation of a player, the post data including the profile image, which is linked to the in-game community to which the player is affiliated, and link information used to make a participation application to the in-game community.

In the program, the information processing system, and the information processing method of the present embodiment, since post data that is available to be posted to an external service and that includes a profile image linked to an in-game community and link information used to make a participation application to the in-game community is created on the basis of a specific operation of a player, the convenience of a recruitment activity of the in-game community using an external service is improved. Furthermore, in the present embodiment, since the post data includes link information used to make a participation application to the in-game community, the convenience is improved when another player who becomes interested in participating therein after seeing the post to the external service makes a participation application to the in-game community.

An embodiment of the present invention will be described below. Note that this embodiment to be described below does not unreasonably limit the contents of the present invention described in the claims. Furthermore, not all of the configurations described in this embodiment are essential constituent requirements of the present invention.

### 1. Configuration of Information Processing System

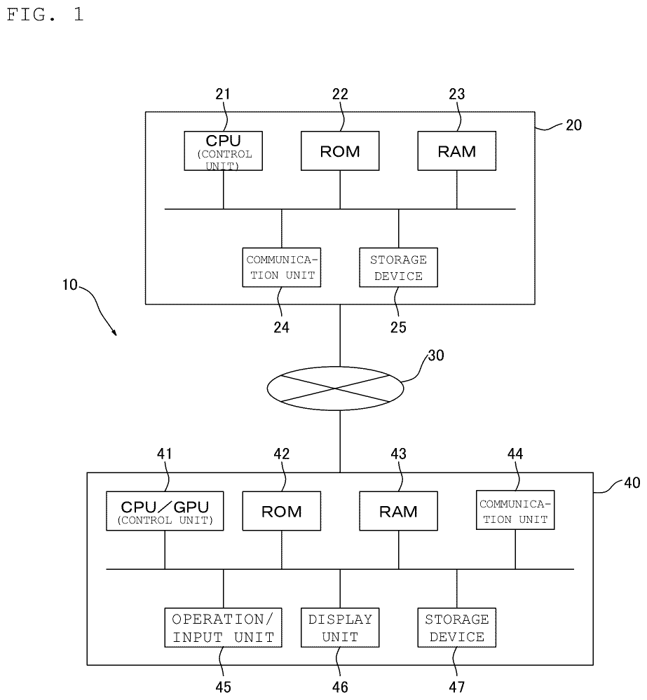

FIG. 1 is a view showing one example of the overall hardware configuration of an information processing system 10 according to this embodiment. In the information processing system 10 of this embodiment, a server 20 and a player terminal 40 are connected by a network 30 such as the Internet, a mobile phone network, a LAN, a WAN, or the like, whereby a so-called client-server type communication system is configured.

The server 20 includes a CPU 21 (control unit), a ROM 22, a RAM 23, a communication unit 24, and a storage device 25.

The CPU 21 executes various kinds of processing by reading programs and data stored in the ROM 22. The RAM 23 is used as temporary storage areas, such as a main memory, a work area, etc., of the CPU 21. The communication unit 24 is configured by a communication module and a communication interface and performs communication processing with the player terminal 40 and other external devices via the network 30. The storage device 25 is an auxiliary storage device, such as a flash memory, an HDD, or an SDD, and stores a program related to a game, identification information such as the ID of a player who uses the player terminal 40, and various kinds of information of each player that are necessary for the game.

The player terminal 40 is a device used to play a game according to this embodiment and is, for example, a smartphone, a tablet, a personal computer, a handheld game console, a stationary game console installed in a store or home, or the like. The player terminal 40 includes a CPU/GPU 41 (control unit), a ROM 42, a RAM 43, a communication unit 44, an operation/input unit 45, a display unit 46, a storage device 47, and a speaker 48.

The CPU/GPU 41 executes various kinds of processing by reading programs and data stored in the ROM 42 into the RAM 43. The ROM 42 stores programs necessary to enable the player terminal 40 to operate. Instead of the ROM 42, a flash memory (NVRAM) may be adopted. The RAM 43 is used as temporary storage areas, such as a main memory, a work area, etc., of the CPU/GPU 41. The communication unit 44 is configured by a communication module and a communication interface and performs communication processing with the server 20 and other external devices (including other player terminals 40) via the network 30. The operation/input unit 45 is a device for accepting various operations and inputs performed by the player and corresponds to a touchscreen, a keyboard, a mouse, a game controller, a microphone, etc. Note that, in the case where the display unit 56 is a display panel having a touchscreen therein, the touchscreen is included in the operation/input unit 45. The display unit 46 is a liquid crystal display or an organic EL display that displays various kinds of information such as images for the game provided by the information processing system 10 of this embodiment. The storage device 47 is an auxiliary storage device, such as a flash memory, an HDD, or an SDD, and mainly stores a program related to a game, various kinds of data related to the game, etc. The speaker 48 is a device that outputs BGM and various sounds for the game provided by the information processing system 10 of this embodiment.

Note that functions and processing of the player terminal 40 are realized when the CPU/GPU 41 reads a program stored in the ROM 22 or the storage device 47 and executes this program. Furthermore, it is also possible that the CPU/GPU 41 reads a program stored in a recording medium that is detachable from the player terminal 40 and executes this program. Furthermore, a form for supplying a program to the player terminal 40 may be a computer-readable recording medium, such as a CD-ROM, that has stored the program or a transmission medium, such as the Internet, that transmits the program. In this embodiment, a description will be given on the assumption that the player terminal 40 is a smartphone provided with a display panel having a touchscreen therein.

The information processing system 10 of this embodiment has a function of providing, via the player terminal 40, a game in which a character with the motif of a racehorse is nurtured, and the nurtured character is made to participate in a race to compete with other characters. In particular, the information processing system 10 of this embodiment has: a nurture function of nurturing a character; a circle function of enabling interaction between players who are affiliated to a circle (one example of an in-game community); a competition function of showing a race competition between a nurtured character and other characters; a live viewing function of showing a singing live of a character; a photo function of capturing, storing, and viewing a screenshot image of a game screen; etc. A description will be given below of a case in which these functions are mainly realized by the player terminal 40. However, the above-mentioned functions may be mainly realized by the server 20 or may be realized by the server 20 and the player terminal 40 in a shared manner.

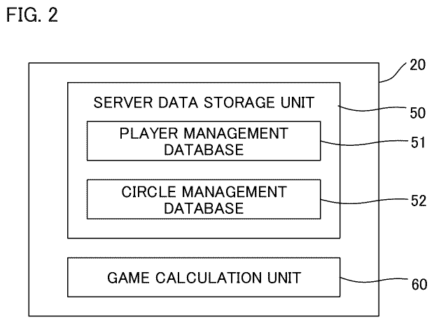

FIG. 2 is a functional block diagram showing main functions of the server 20.

The server 20 in the information processing system 10 has a function of managing players, characters, etc., by using various kinds of identification information and a function of performing calculations required to progress the game in response to requests from the player terminal 20 and sending the calculation results to the player terminal 40. These functions are realized in cooperation between a server data storage unit 50 and a game calculation unit 60.

The server data storage unit 50 includes a player management database 51 and is mainly realized by the storage device 25. In this embodiment, a character list, an item list, a nurture target list, etc., are stored in the player management database 51 while being linked to a player ID given to each player.

The character list includes, for example, a character individual ID given to each nurtured character, a character type ID indicating the type of a character, the statuses of a character (rarity, evaluation points, course aptitude, distance aptitudes, running-style aptitudes, running way, speed, stamina, power, spirit, wisdom, possessed skills, and an obtained title(s)), a lock state (locked or unlocked), and the nurture history of a character (nurture condition and race results during nurture).

In this embodiment, a “nurtured character” means a character that has been nurtured and of which the statuses have been determined at the end of the nurture thereof, by the nurture function, which is one of game functions realized by the information processing system 10 of this embodiment.

Furthermore, in this embodiment, a “character individual ID” and a “character type ID” are used, and the difference therebetween is as follows.

First, the “character individual ID” is given when a character that has been nurtured in the nurture function is registered to the character list. The “character individual ID” is used to identify each nurtured character linked to the player ID.

Furthermore, this embodiment has a specification in which a player selects a nurture target from among a plurality of types of characters in the nurture function. The “character type ID” is given to identify the type of a nurture-target character.

Furthermore, the “lock state” indicates whether transfer of a nurtured character (deletion from the character list) is prohibited or not, transfer is allowed in the case of an unlocked state, and transfer is not allowed in the case of a locked state. Example situations of being in the locked state include: when the player individually specifies the locked state from the list of nurtured characters; and when a nurtured character is registered to participate in a race.

In the nurture target list, data in which information indicating “released” or “not released” is associated with each character type ID is stored. In this embodiment, a character with which information indicating “released” is associated in the nurture target list is a character that can be selected by the player as a nurture target in the nurture function. Furthermore, in this embodiment, it is possible to newly release a character by using a release item or by a character acquisition lottery, and the number of characters that can be selected as a nurture target(s) is different depending on the player. Hereinafter, a character that can be selected as a nurture target in the nurture function is referred to as a released character, in some cases.

The item list includes data related to items, strengthening points, trainer points (TPs), and in-game currency that are possessed by the player. In this embodiment, for example, the content of and the number of possessed items, the amount of possessed strengthening points, the amount of possessed trainer points (TPs), the amount of possessed in-game currency, etc., are stored, in the form of the item list, in the player management database 51.

Examples of items in this embodiment are, for example, an item used to support nurture of a character, an item used to change the condition of a race to participate, etc. Those items can be obtained in accordance with the result of a race or by consuming the in-game currency.

Furthermore, the strengthening points are used, for example, to strengthen support items that are items for supporting the nurture of a character. A character can be nurtured in a more advantageous nurture environment as the support items are strengthened.

Furthermore, the trainer points (TPs) are used to nurture a character by using the nurture function. Nurture of a character can be started by consuming the trainer points (TPs) corresponding to the amount of consumption required for one event of nurture, when the nurture is started.

Furthermore, a friend list is data stored in the player management database 51. In this embodiment, it is possible to register another player as a friend and to rent and use a character or a support item from said another player registered as a friend, in the nurture function. The friend registration is performed as follows: the player ID of another player is input in a friend registration screen displayed on the display unit 44 of the player terminal 40, and, if the player corresponding to the player ID exists and if friend registration of the player is enabled, a tap input is performed with respect to a registration button provided in the friend registration screen, whereby the player ID of said another player who is a registration-target is added to the friend list. Since an upper limit (for example, 50) on the number of friends that can be registered is provided for each player, and an upper limit (for example, 100) on the number of times to be registered as a friend is also provided for each player, it is possible to perform new friend registration if the corresponding upper limit has not been reached.

The server data storage unit 50 includes a circle management database 52 and is mainly realized by the storage device 25. In this embodiment, an affiliated-player list, circle setting information, circle chat information, item donation information, circle ranking information, related information of a circle card image (one example of a profile image), etc., are stored in the circle management database 52 while being linked to a circle ID given to each circle.

In the affiliated-player list of each circle, player IDs of players who are affiliated to the circle are stored while being linked to the circle ID. Furthermore, member attributes of the players affiliated to the circle are also stored in the affiliated-player list. In this embodiment, the member attribute of the leader or a member is assigned to each of the players affiliated to the circle. The player who has established the circle becomes the leader at the time of the establishment. For one circle, one player is set as the leader. The member attribute of the leader can be given to another player. The member attributes of the players who are not the leader are each set to a member.

The leader has the right to change the circle setting information, which includes a circle name, a circle activity policy, and a circle participation method. Furthermore, the leader can also perform approval of participation of a player who has applied for participation, expulsion of an affiliated player, and editing of a circle card image. On the other hand, the members have no rights to change the circle name, to change the circle activity policy, to change the condition for participation in the circle, to approve participation of a player who has applied for participation, to expel an affiliated player, and to edit a circle card image.

The circle setting information includes the circle name, the circle activity policy, and the circle participation method, which are set as required items at the time of the establishment of the circle by the player who has established the circle. In this embodiment, only the leader has the right to change the circle setting information.

The circle chat information is information of the chat history of the players affiliated to the circle. In this embodiment, the circle chat information stored in the circle management database 52 is updated every time a post content such as a text or a sticker is sent from the player terminal 40 using the circle function.

The item donation information is information related to a function of recruiting an item and donating the recruitment-target item between the players affiliated to the circle. In the circle management database 52, information of recruitment of an item and information of donation with respect to the recruitment are stored for each circle.

The circle ranking information is information including: a monthly fan acquisition count obtained by aggregating, on a monthly basis, the total number of fans acquired in the nurture function by the players affiliated to the circle; the order of the circle based on the monthly fan acquisition count; and the current circle rank based on the order of the circle in the previous month.

The circle card image is a profile image on which information of the circle is posted, and the right to edit the profile image is set only for the player of which the member attribute in the circle is the leader. In this embodiment, the leader edits the circle card image and, when finishing the editing of the circle card image, uploads related information of the circle card image to the server 20 from the player terminal 40 of the leader, and the circle card image is stored in the circle management database 52. The related information of the circle card image includes illustration-part related information and text-part related information. In the illustration-part related information, in the case where an image preset that is prepared in advance on the game side is used in the circle card image, a character type ID of a display character, a background ID, and a theme ID are stored while being linked to the circle ID, and, in the case where a screenshot image that is captured by the player is used therein, the screenshot image is stored while being linked to the circle ID. Furthermore, in the text-part related information, text data of an introductory sentence and a comment that are to be stated in the circle card image as pieces of profile information of the circle is stored while being linked to the circle ID. Thereafter, the leader and the members of the circle can download the related information of the circle card image and the circle setting information, which are stored in the circle management database 52, restore the circle card image at the player terminals 40 of the individual players, and view the restored circle card image. Note that it is also possible that the circle card image itself is stored in the circle management database 52 while being linked to the circle ID. In this case, the leader and the members of the circle can download the circle card image stored in the circle management database 52 and view the circle card image at the player terminals 40 of the individual players. Furthermore, although the right to edit the circle card image is not set for the players of which the member attributes are members, the players affiliated to the circle are enabled to view the circle card image and to post the circle card image to an external service, regardless of whether the member attributes thereof are the leader or the members.

The game calculation unit 60 performs processing for performing calculation required to progress the game and sending the calculation result to the player terminal 40 in response to a request from the player terminal 20, processing for sending data required to progress the game to the player terminal 40 in response to a request from the player terminal 20, etc. The game calculation unit 60 is mainly realized by the CPU 21 and the communication unit 24. For example, when a request related to a training direction is received from the player terminal 20 in the nurture function, the game calculation unit 60 calculates a result indicating either success or failure of the training and sends the calculation result to the player terminal 40. Furthermore, for example, when a request related to participation in a race is received in the nurture function, the game calculation unit 60 performs race simulation of a plurality of characters including a nurture-target character and non-player characters (NPCs) and sends the result of the race simulation to the player terminal 40.

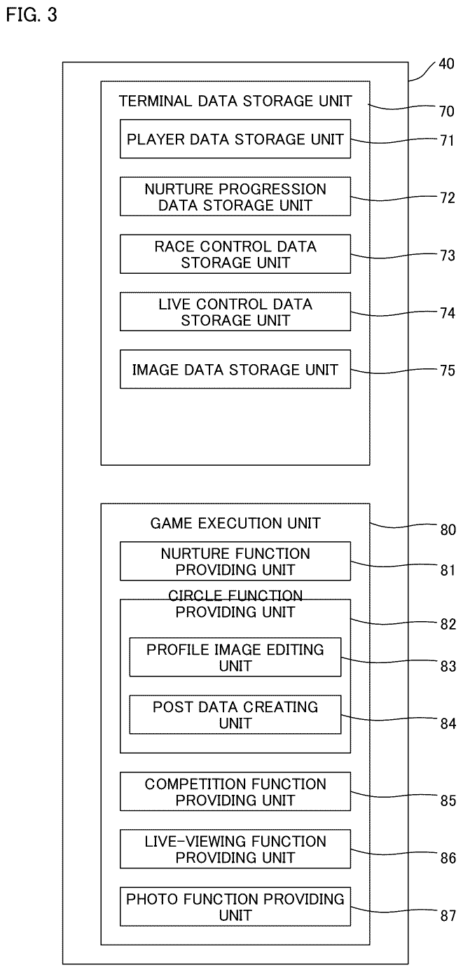

FIG. 3 is a functional block diagram showing main functions of the player terminal 40.

As shown in FIG. 3, in the player terminal 40 in the information processing system 10 of this embodiment, the nurture function, the circle function, the competition function, the live viewing function, the photo function, etc., are realized through cooperation of a terminal data storage unit 70 and a game execution unit 80.

The terminal data storage unit 70 stores data used when the game execution unit 80 performs various kinds of processing, and is mainly realized by the storage unit 42.

The terminal data storage unit 70 includes a player data storage unit 71. The player data storage unit 71 stores a character list, a nurture target list, an item list, a friend list, and data related to an affiliation circle that are associated with the player ID. In this embodiment, at the start and the end of the application and in the other necessary situations, synchronous processing is performed, between the player data storage unit 71 of the player terminal 40 and the player management database 51 and the circle management database 52 of the server 20, on data (the character list, the nurture target list, the item list, the friend list, etc.,) linked to the player ID, and various kinds of game processing are executed by using the data stored in the player data storage unit 71. In this embodiment, in the case where it becomes necessary to change the character list, the nurture target list, the item list, the friend list, and the affiliation circle, along with execution of the various kinds of game processing, the storage content of the player data storage unit 71 is updated, and the updated storage content is backed up to the player management database 51 and the circle management database 52 of the server 20, whereby the storage contents of both are synchronized. Note that the data linked to the player ID, such as the character list, the nurture target list, the item list, the friend list, and the affiliation circle, may also be downloaded from the player management database 51 and the circle management database 52 to the player data storage unit 71, as needed, e.g., at the start of the application.

Furthermore, the terminal data storage unit 70 includes a nurture progression data storage unit 72, and the nurture progression data storage unit 72 stores data (nurture progression data) necessary for progression of the nurture function of a character (character having the character type ID with which information indicating “released” is associated in the nurture target list) that can be selected as a nurture target in the nurture function. In this embodiment, nurture goals and game events related to the nurture function are prepared for each character, and the nurture progression data including at least the setting content of the nurture goals and the setting content of the game events is stored in the nurture progression data storage unit 72 while being linked to the character type ID.

Furthermore, the terminal data storage unit 70 includes a race control data storage unit 73, and the race control data storage unit 73 stores data for controlling the movement of a character and a production of skill activation when a race in which the character participates is shown in the nurture function and the race competition function, and text data and audio data for race commentary, etc.

Furthermore, the terminal data storage unit 70 includes a live control data storage unit 74, and the live control data storage unit 74 stores music data, character's singing data, character's movement data, etc., related to the live viewing function.

Furthermore, the terminal data storage unit 70 includes an image data storage unit 75, and the image data storage unit 75 stores a screenshot image acquired by using the photo function. In this embodiment, it is possible not only to view the screenshot image stored in the image data storage unit 75 in the photo function but also to use the screenshot image for editing the circle card image in the circle function.

The game execution unit 80 performs processing for starting the game in the case where a game start condition is satisfied, processing for executing a game mode selected from among a plurality of types of game modes, processing for making the game progress, processing for making an event occur in the case where an event occurrence condition is satisfied, processing for calculating a game result, processing for ending the game in the case where a game end condition is satisfied, processing for requesting the server 20 to perform calculation, processing for obtaining a calculation result and necessary data from the server 20, and processing for sending a calculation result and data of the player terminal 40 to the server 20. The game execution unit 80 is mainly realized by the CPU/GPU 41 and the communication unit 44. In this embodiment, the game execution unit 80 includes a nurture function providing unit 81, a circle function providing unit 82, a competition function providing unit 85, a live-viewing function providing unit 86, and a photo function providing unit 87.

The nurture function providing unit 81 performs processing for providing the nurture function of nurturing a character. In this embodiment, the nurture function providing unit 81 accepts an input related to nurture of a character and displays a calculation result with respect to the input.

In this embodiment, when a character is nurtured in the nurture function, it is required to select, in each turn, an action that is a target for turn consumption. Examples of a turn-consumption target action include training, participation in a race, going out, infirmary, etc. The nurture function providing unit 81 accepts selection of a turn-consumption target action via a nurture home screen etc. displayed on the display unit 46 and requests the server 20 to calculate the result with respect to the selected action. At the server 20, after receiving the request, calculation for the result with respect to the selected action is performed, and the calculation result is sent to the player terminal 40. The nurture function providing unit 81 displays, on the display unit 46, a display screen corresponding to the calculation result received from the server 20.

The circle function providing unit 82 performs processing for providing the circle function, in which players affiliated to the same circle can interact with one another. In this embodiment, in the circle function, the players affiliated to the same circle can perform chat interaction, item donation, competition, etc. The circle function providing unit 82 accepts, in a circle chat provided in a circle top screen, an input of text etc. for performing chat interaction, item donation, or competition, and performs processing for sending, to the server 20, the post content to the circle chat. At the server 20, after receiving the post content, the circle chat information stored in the circle management database 52 is updated, and the post content is reflected in the circle chat when the circle top screen is displayed on the player terminals 40 of the players affiliated to the same circle.

Furthermore, the circle function providing unit 82 includes a profile image editing unit 83 and a post data creating unit 84.

The profile image editing unit 83 performs processing for enabling editing of the circle card image, which includes information of the circle. In this embodiment, the profile image editing unit 83 gives the right to edit the circle card image to the player of which the member attribute is set to the leader, whereby control is performed such that the circle card image can be edited at the player terminal 40 of the leader, and the circle card image cannot be edited at the player terminals 40 of the members.

The post data creating unit 84 creates post data that can be used to be posted to an external service. On the basis of the fact that a predetermined input has been performed in a circle card screen in which the circle card image can be viewed, the post data creating unit 84 creates post data including a circle-member recruiting text, a search hashtag, the circle card image linked to the circle to which the player is affiliated, and link information (for example, an URL address etc.) to be used to apply for participation in the circle, and outputs the post data to a shared memory area (for example, a clipboard or the like) in the storage device 47 of the player terminal 40. The shared memory area to which the post data is output is a memory area that is accessible from a plurality of different applications and that can be used to pass data between the applications. In this embodiment, link information used to make a participation application to the circle is a so-called deep link, and, when the link information is used in the player terminal 40, the game application can be automatically activated, and a participation-application dialog for the circle corresponding to the link information can be called.

In this embodiment, in the case where posting of the circle card image to an external service is performed while the circle function is used, the circle function providing unit 82 calls an external-service sharing function of the operating system of the player terminal 40 to enable a posting-destination external service to be selected. When the player selects a posting-destination external service, the circle function providing unit 82 calls a posting input form of the external service and waits for a player's posting decision input in a state in which the post data stored in the shared memory area of the storage device 47 is automatically input to the posting input form. That is, the circle function providing unit 82 performs processing for assisting in posting the circle card image to an external service.

The competition function providing unit 85 performs processing for providing the race competition function of making a nurtured character possessed by the player compete against nurtured characters of other players and/or non-player characters (NPCs), in a race.

In this embodiment, in the case where the player is the organizer of a race, it is possible to set the number of participation registrations within the range from nine to eighteen characters, to register at most three nurtured characters for participation, and to make the remaining participation slots filled up with nurtured characters of other players and/or non-player characters (NPCs), thus enabling a race competition of those characters registered for participation. Furthermore, in the case where another player is the organizer of a race and there are empty slots in the number of participation registrations with respect to the race, it is possible to register at most three nurtured characters for participation, thus enabling a race competition of characters registered for participation, as in the case where the player him/herself is the organizer of a race.

In the case where the organizer of a race permits participation at the player terminal 40, a race simulation is executed at the server 20, and the competition function providing unit 85 enables the player terminal 40 to make a request to the server 20 for the result of the race simulation. At the player terminal 40, after receiving the result of the race simulation from the server 20, the competition function providing unit 85 generates a race video based on the result of the race simulation on the basis of various kinds of data stored in the race control data storage unit 73 and displays the generated race video on the display unit 46, whereby the player can view the race.

The live-viewing function providing unit 86 performs processing for providing the live viewing function of showing a singing live of a character that can be selected as a nurture target in the nurture function by the player and/or a non-player character (NPC).

In this embodiment, in the live viewing function, the player can select a character(s) that is to participate in a live and view a singing live of the member(s) selected by the player. Songs in the singing live can be selected from among a plurality of kinds of songs, and the live-viewing function providing unit 86 generates a live video on the basis of data corresponding to the selected songs stored in the live control data storage unit 74 and displays the generated live video on the display unit 46, whereby the player can view the singing live.

The photo function providing unit 87 performs processing for providing the photo function of acquiring, saving, and browsing a screenshot image of the game screen.

In this embodiment, acquisition of a screenshot image using the photo function can be performed while a race video is being viewed in the competition function and while a live video is being viewed in the live viewing function. In the photo function, ON and OFF can be switched in the setting of an input interface, and, in the case where the photo function is set to ON, an image acquisition button is disposed on the display screen for the race video or the live video. When the player taps the image acquisition button at an arbitrary timing, the race video or the live video is paused, and a screenshot image is acquired. Then, when the player performs an input for determining saving of the acquired screenshot image, the acquired screenshot image is saved in the image data storage unit 75. Furthermore, in the photo function, it is possible to display a list of screenshot images and to browse an arbitrary screenshot image(s). Furthermore, a screenshot image stored in the image data storage unit 75 can be used to create a circle card image in the circle function.

### 2. Control Technique of This Embodiment

A control technique of this embodiment will be described below by using an example case in which a game program of this embodiment is applied to a game application in the player terminal 40, which is provided as a smartphone.

The game program of this embodiment is configured so as to be able to provide a plurality of kinds of game functions. In the nurture function, which is a main game function, a nurture-target character is selected from among a plurality of kinds of characters, the statuses of the character change in accordance with the progression of the game, and, when a predetermined end condition is satisfied, the statuses of the character are determined, and the nurture thereof ends. This nurtured character can be made to participate in a race competition with characters nurtured by other players, in the competition function, which is another game function. Furthermore, in this embodiment, a possession quota of nurtured characters (the number of nurtured characters that can be registered in the character list) is set in advance, and, when the upper limit (for example, 240 characters) of the possession quota of nurtured characters is reached, it becomes impossible to nurture a new character in the nurture function. Thus, it is necessary to delete a nurtured character from the character list to secure the possession quota.

In the information processing system 10, to which the game program of this embodiment is applied, the circle function is provided to prompt interaction between players. In the case where a player is not affiliated to a circle, the player can establish a new circle and can participate in an existing circle created by another player.

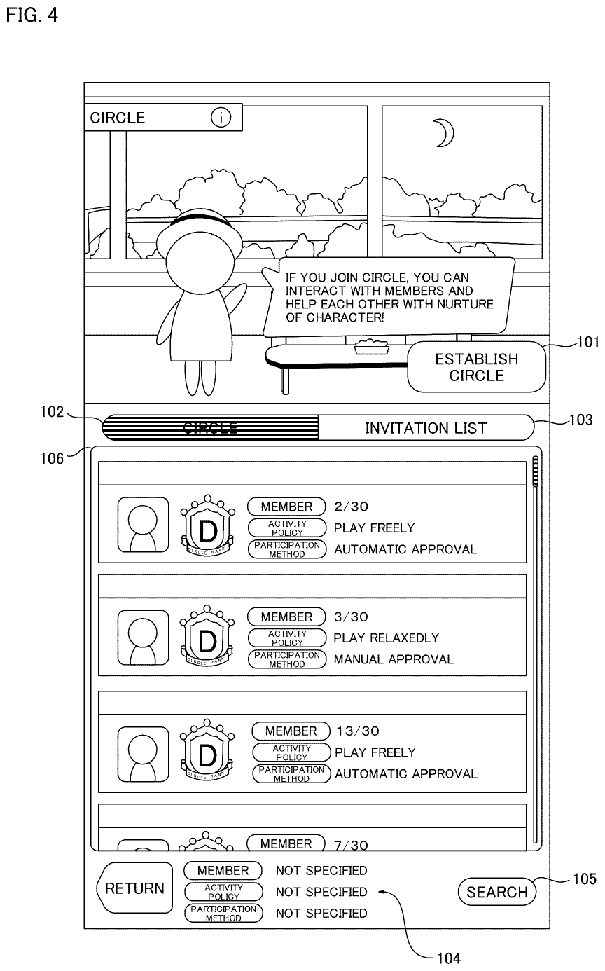

FIG. 4 is a view showing one example of a circle search screen displayed when the player starts the circle function in a state in which the player is not affiliated to a circle. In the case where a circle is to be established, a tap input is performed with respect to a circle setting button 101, thereby making it possible to set various items necessary to establish the circle. In the case where a new circle is to be established, the player determines at least the circle name, the activity policy, and the participation method (automatic approval or manual approval). The member attribute of the player who has established the circle is set to the leader at the time of the establishment. In the case where the player is to participate in an existing circle, the player can search for a circle to which a participation application is made, by using the circle search screen. In the circle search screen, a circle tab 102 and an invitation list tab 103 are provided. In the case where the circle tab 102 is selected, circles that match search conditions displayed in a search-condition display area 104 are displayed in a list in a circle-list display area 106. When the search conditions are changed, and a tap input is performed with respect to a search button 105, the circle-list display area 106 is updated so as to display, in a list, circles that match the changed search conditions. In this embodiment, the leader of an existing circle can invite another player to join the circle of the leader, and, when the leader invites a player by specifying the player ID thereof, the leader is registered in an invitation list of the invited player. In the case where the invitation list tab 103 is selected in the circle search screen, if the player is invited by the leader of an existing circle, the circle of the leader who has invited the player is displayed in the circle-list display area 106.

When the player makes a participation application to a circle, and the participation application is approved, the player can be affiliated to the circle as a member. Note that, for each circle, the leader can set automatic approval or manual approval as the participation method. In the case where the participation method is set to automatic approval, when players make participation applications, the participation applications are automatically approved. In the case where the participation method is set to manual approval, players who have made participation applications are registered in an approval waiting list for the circle, and only a player(s) of which the participation application(s) is approved by the leader can be affiliated to the circle.

In the circle function in the information processing system 10 of this embodiment, the number of fans obtained when individual players affiliated to a circle nurture characters in the nurture function is aggregated on a monthly basis, and the circle ranking is determined by ranking each circle on the basis of the aggregated result. In this embodiment, for each circle, the monthly fan acquisition count, which is obtained by the affiliated players, and the circle ranking are stored as the circle ranking information, in the circle management database 52. Furthermore, in the circle function, at the beginning of each month, rewards (items and in-game currency) based on the circle ranking at the end of the previous month are distributed to the players affiliated to the circle.

In order to aim for the top of the circle ranking, it is preferred that a large number of players who play as actively as possible are affiliated to the circle. If the number of players affiliated to the circle is reduced due to withdraw or the like of an affiliated player(s), the circle ranking is likely to decline. Thus, when the number of players affiliated to the circle is reduced, the leader may need to replenish players. However, it is not always the case that players search for a circle in the game and gather in a circle that recruits players, and other players may avoid making participation applications to circles that have just been established and circles that have a small number of players.

Thus, in this embodiment, in the circle function, the circle card image, which is used to introduce the circle to other players, can be edited, and the technique of assisting in creating post data, including the circle card image and link information for making a participation application to the circle, and in posting the created post data to an external service, such as a social networking service (SNS), is adopted.

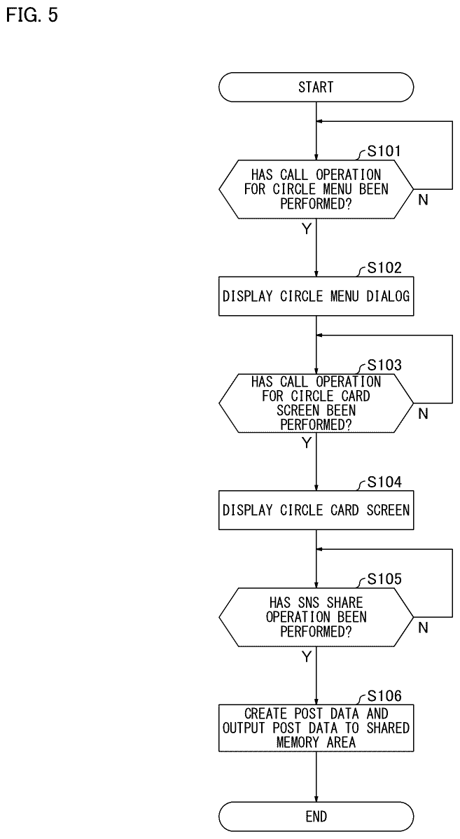

FIG. 5 is a flowchart showing the flow of processing leading to creation of post data.

First, when a call operation for a circle menu is performed in the player terminal 40 (Y in Step S101), a circle menu dialog is displayed (Step S102).

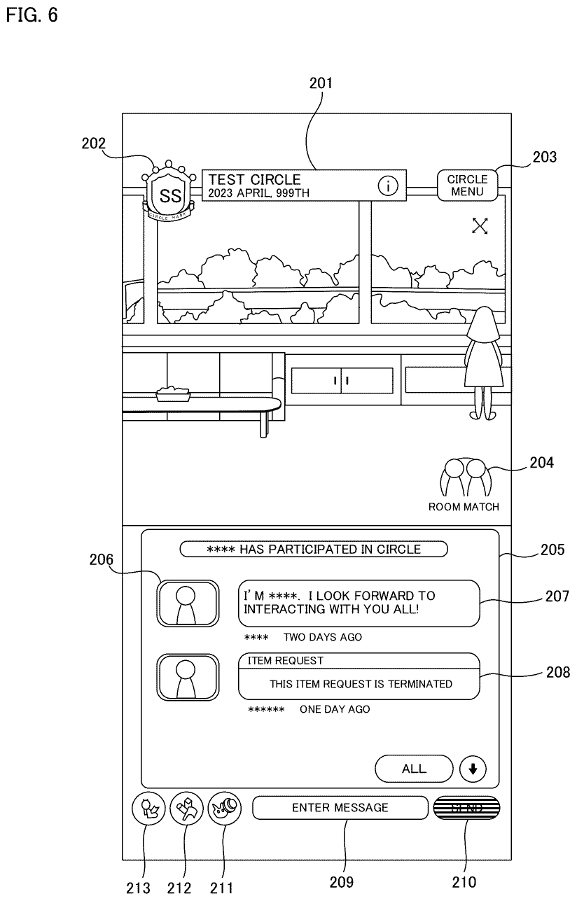

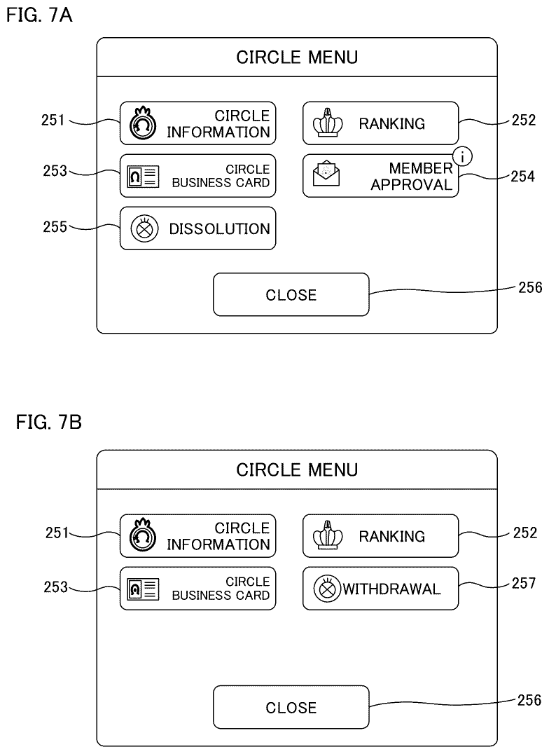

In this embodiment, in the case where the player is affiliated to a circle, when the circle function is started, a circle home screen is displayed on the display unit 46 of the player terminal 40, as shown in FIG. 6. In the circle home screen, a circle name display area 201 for displaying a circle name and a circle ranking, a circle rank icon 202 for displaying a circle rank determined according to the circle ranking, and a circle menu button 203 for calling the circle menu dialog are disposed at an upper section. Furthermore, in the circle home screen, a room match button 204 is provided, and, when a tap input is performed with respect to the room match button 204, the competition function is called, and a competition room can be set. Furthermore, in the circle home screen, a circle chat display area 205 is provided, and messages, item donation recruitment, etc., that are posted by individual players affiliated to the circle are displayed in the circle chat display area 205, whereby the players can interact with one another. In the circle chat display area 205, a player who has posted a message or the like can be identified by a member icon 206. Furthermore, in the case where a message is to be posted in the circle chat display area 205, when a tap input is performed with respect to a message entry area 209, a text can be input, and, when a tap input is performed with respect to a send button 210, the post content input to the message entry area 209 is posted to the circle chat display area 205 and is also sent to the server 20, whereby the circle chat information stored in the circle management database 52 is updated. When a tap input is performed with respect to a sticker button 211, a sticker can be selected. When a sticker is selected, the sticker can be posted to the circle chat. In the player terminal 40 of another player who is affiliated to the same circle, in the case where communication with the server 20 is performed with the circle home screen being displayed, the circle chat information stored in the circle management database 52 is obtained, and the post content is reflected in the circle chat display area 205. In this embodiment, an item request 208 that indicates item donation recruitment is also displayed in the circle chat display area 205. In the case where an item request is to be made, when a tap input is performed with respect to a request button 212, it is possible to select an item of which donation is to be recruited and to post an item request to the circle chat. Furthermore, in the case where the player wishes to share a nurtured character thereof, as a practice partner in a race, with another player, when a tap input is performed with respect to a practice partner share button 213, the nurtured characters possessed by the player are displayed in a list, and it is possible to select one of the nurtured characters and to post a practice partner share request to the circle chat. In this embodiment, the above-mentioned tap input performed with respect to the circle menu button 203 becomes a call operation for the circle menu, and the circle menu dialog is displayed, as shown in FIG. 7A or FIG. 7B, on the basis of the fact that the call operation for the circle menu has been performed.

In this embodiment, the display content of the circle menu dialog is different depending on the member attribute of a player.

FIG. 7A shows a display example of the circle menu dialog in the case where the member attribute is the leader. In the circle menu dialog for the leader, a circle information button 251, a ranking button 252, a circle card button 253, a member approval button 254, a dissolution button 255, and a close button 256 are provided.

The circle information button 251 is a button for making a transition to a circle information screen in which the circle ranking, the number of affiliated players, the participation method, the activity policy, and an affiliated-player list of the circle can be viewed. In the case where the member attribute is the leader, changes to the circle setting information, which includes the circle name, the circle activity policy, and the circle participation method, can be made in the circle information screen.

The ranking button 252 is a button for making a transition to a circle ranking screen in which, in addition to the circle ranking of the circle to which the leader is affiliated, circles in the top 100 (1st to 100th) of the circle ranking can be viewed.

The circle card button 253 is a button for making a transition to the circle card screen, in which the circle card image of the circle to which the leader is affiliated can be viewed. That is, a tap input with respect to the circle card button 253 is a call operation for the circle card screen.

The member approval button 254 is a button for making a transition to a participation application list screen in which a list of players who have made participation applications is displayed, and approval therefor can be performed.

The dissolution button 255 is a button used to dissolve the circle, and, when a tap input is performed with respect to the dissolution button 255, a dialog for asking for confirmation of the dissolution of the circle is displayed. When an input for determining the dissolution is performed in the dialog, a circle dissolution request is sent to the server 20, and the circle related to the circle dissolution request is deleted from the circle management database 52 in the server 20, whereby the circle is dissolved.

The close button 256 is a button for closing the circle menu dialog, and, when a tap input is performed with respect to the close button 256, the circle menu dialog is closed, thus returning to the circle home screen.

FIG. 7B shows a display example of the circle menu dialog in the case where the member attribute is a member. In the circle menu dialog for a member, the circle information button 251, the ranking button 252, the circle card button 253, a withdrawal button 257, and the close button 256 are provided. The difference from the circle menu dialog for the leader is that the withdrawal button 257 is provided instead of the member approval button 254 and the dissolution button 255.

The withdrawal button 257 is a button for withdrawing from the circle to which the member is affiliated, and, when a tap input is performed with respect to the withdrawal button 257, a dialog for asking for confirmation of the withdrawal from the circle is displayed. When an input for determining the withdrawal is performed in the dialog, a circle withdrawal request is sent to the server 20, and, in the server 20, the player who has sent the circle withdrawal request is deleted from the affiliated-player list of the corresponding circle in the circle management database 52, whereby the withdrawal of the player from the circle is completed.

Then, when a call operation for the circle card screen (a tap input with respect to the circle card button 253) is performed with the circle menu dialog being displayed (Y in Step S103), the circle card screen is displayed (Step S104).

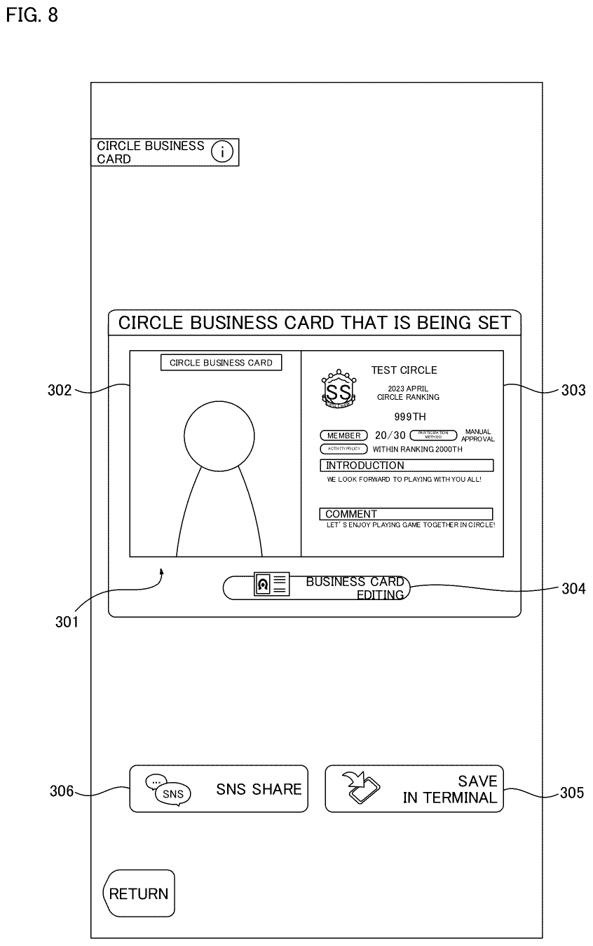

FIG. 8 is a view showing a display example of the circle card screen. In the circle card screen, a circle card image 301 can be viewed. In the circle card image 301, an illustration area 302 and a profile area 303 are provided. An image based on one of an image of a released character that is possessed by the leader, an image of a support item that is possessed by the leader, and a screenshot image acquired by using the photo function is displayed in the illustration area 302. In the initial settings, an image of a character determined in advance (for example, an initial character that is set to be possessed by all players from the start of the game) is set in the illustration area 302. Of the profile information of the circle, the circle name, the circle rank, the circle ranking, the number of affiliated players, the participation method, the activity policy, the introductory sentence, and the comment are displayed in the profile area 303. In the initial settings, the comment is set to a fixed comment that is determined in advance, and, regarding the other items, the corresponding kinds of circle setting information registered in the circle management database 52 are set in the profile area 303.

Furthermore, in the circle card screen, a card edit button 304 is provided. In this embodiment, since the right to edit the circle card image is set depending on the member attribute of a player affiliated to the circle, the card edit button 304 is enabled and normally displayed in the circle card screen for the player of which the member attribute is the leader, and the card edit button 304 is disabled and grayed out in the circle card screen for the player of which the member attribute is the member. When a tap input is performed with respect to the card edit button 304 with the circle card screen being displayed in the player terminal 40 of the leader, the display screen is transitioned to a card edit screen.

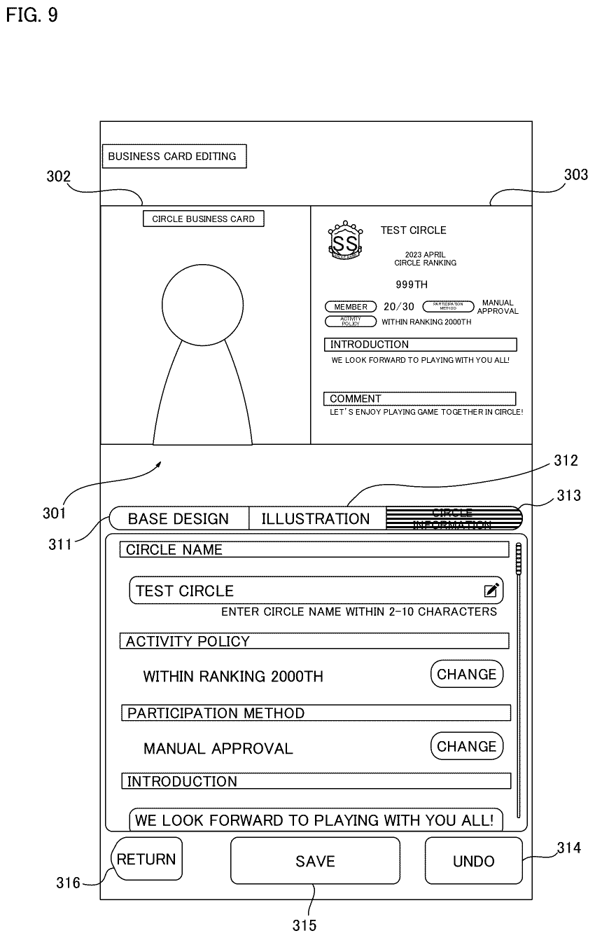

FIG. 9 is a view showing a display example of the card edit screen. In this embodiment, in the case where the member attribute is the leader, this player has the right to edit the circle card image, and, in the case where the member attribute is the member, this player does not have the right to edit the circle card image. Thus, the card edit screen can be displayed on the player terminal 40 of the leader, whereas the card edit screen cannot be displayed on the player terminal 40 of the member. In this way, in this embodiment, since the right to edit the circle card image is given only to the leader, it is possible to prevent the circle setting information from being modified without the leader, who runs the circle, knowing it.

In the card edit screen, a base design tab 311, an illustration tab 312, and a circle information tab 313 can be used to switch editing of one of the base design, the illustration, and the circle information. The base design is an edit item related to the overall design of the circle card image 301, the illustration is an edit item related to the illustration area 302 in the circle card image 301, and the circle information is an edit item related to the profile area 303 in the circle card image 301.

Regarding the base design, editing is enabled when a tap input is performed with respect to the base design tab 311, and items of illustration arrangement, a theme color, and a card background can be edited.

Regarding the illustration arrangement, the arrangement of the illustration area 302, i.e., whether the illustration area 302 is aligned to left or right, can be set. Although the illustration area 302 is aligned to left in the example shown in FIG. 9, if the illustration area 302 is aligned to right, the position of the illustration area 302 and the position of the profile area 303 are switched.

Regarding the theme color, the color of the border of the circle card image can be set. In this embodiment, color icons of 10 kinds of theme colors are prepared, and the theme color can be changed by tapping any of the color icons.

Regarding the card background, a background pattern for the circle card image can be set. In this embodiment, the card background can be set from among five kinds of background patterns including “no background”.

Regarding the illustration, editing is enabled when a tap input is performed with respect to the illustration tab 312, and an image to be displayed in the illustration area 302 can be edited. The image to be displayed in the illustration area 302 can be set from an image of a released character possessed by the leader, an image of a support item possessed by the leader, or a screenshot image acquired by using the photo function. Note that, in the case where a screenshot image acquired by using the photo function is determined as an illustration used in the circle card image, the used screenshot image is sent to the server 20 in each case and is backed up as an image linked to the circle card image. Furthermore, in the case where an image preset prepared in advance on the game side is used as an illustration used in the circle card image, the IDs of a use-target image of the image preset (the display character ID, the background ID, and the theme ID) are sent to the server 20 and stored as information of the image preset linked to the circle card image.

Regarding the circle information, editing is enabled when a tap input is performed with respect to the circle information tab 313, and the circle name, the activity policy, the participation method, the introductory sentence, and the comment can be edited. In this embodiment, in the case where the circle setting information, such as the circle name, the activity policy, and the participation method, is changed in the card edit screen, the circle setting information linked to the circle ID, which is managed in the circle management database 52, is also updated. That is, in the same way as in the case where the circle information screen is called in the circle menu dialog, and the circle setting information is changed, the content of the change in the circle setting information due to the editing of the circle card image 301 is reflected also in management information in the circle management database 52. In this way, in this embodiment, the circle setting information can be changed also through editing of the circle card image 301, whereby it is possible to improve the convenience of the circle operation of the leader and the work convenience related to changing of the circle setting information.

In the case where the edited content of each of the items is to be discarded in the card edit screen, a tap input is performed with respect to a change discarding button 314, thereby making it possible to discard the edited content. Furthermore, in the case where each of the items is edited via the card edit screen, a tap input is performed with respect to a save button 315, thereby generating a new circle card image 301 in which the edited content has been reflected and updating the card edit screen. The communication with the server 20 due to the above-mentioned change in the circle setting information is executed when a tap input with respect to the save button 315 is performed, and the circle card image is also backed up at the server 20. Furthermore, in the case where editing of the circle card image via the card edit screen is to be finished, a tap input is performed with respect to a return button 316, whereby the screen returns to the circle card screen (FIG. 8).

As shown in FIG. 8, in the circle card screen, a terminal save button 305 is provided. When a tap input is performed with respect to the terminal save button 305, the circle card image is saved in a known data format (for example, JPEG format) in an image storage area (for example, a photo folder or the like) in the storage device 47 of the player terminal 40.

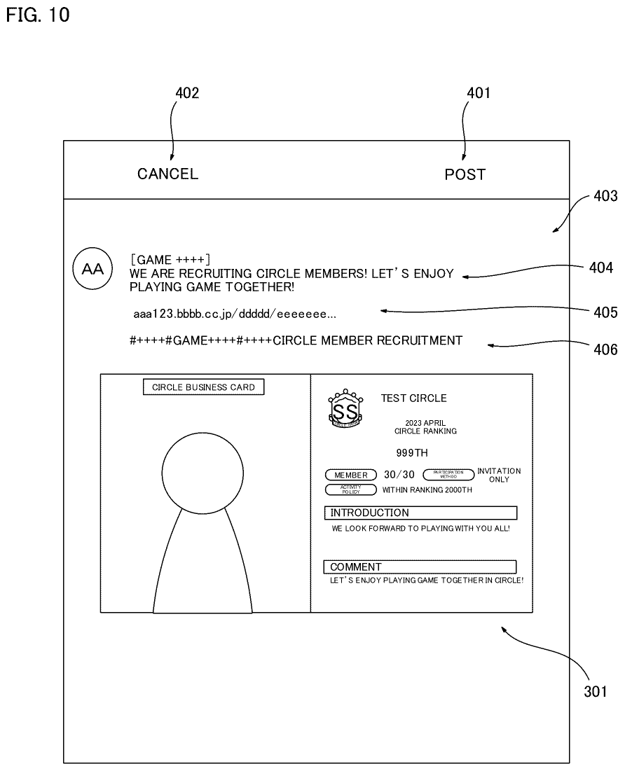

Furthermore, in the circle card screen, an SNS share button 306 is provided. When a tap input (SNS share operation: an example specific operation) is performed with respect to the SNS share button 306 (Y in Step S105), processing for creating post data that can be used to be posted to an external service and outputting the post data to the shared memory area in the storage device 47 of the player terminal 40 is performed (Step S106). Furthermore, when a tap input is performed with respect to the SNS share button 306, the game program of this embodiment calls the external-service sharing function of the operating system of the player terminal 40 and makes the player select an external service to which the post data is posted. When the player selects a posting-destination external service, the post data is automatically input to the posting input form of the selected external service. FIG. 10 is a view showing a state in which the post data has been automatically input to the posting input form of the social networking service (SNS) selected as the posting-destination external service. In the example of the posting input form shown in FIG. 10, a posting operation area 401, a cancel operation area 402, and a post-content confirmation area 403 are provided, and a fixed text 404 related to the game title and circle member recruiting, a circle participation-application link 405, a search hashtag 406, and the circle card image 301 are automatically input. In this posting input form, posting to the social networking service (SNS) can be completed by operating the posting operation area 401, and posting to the social networking service (SNS) can be canceled by operating the cancel operation area 402. Furthermore, the post content can be freely edited in the posting input form by the player.

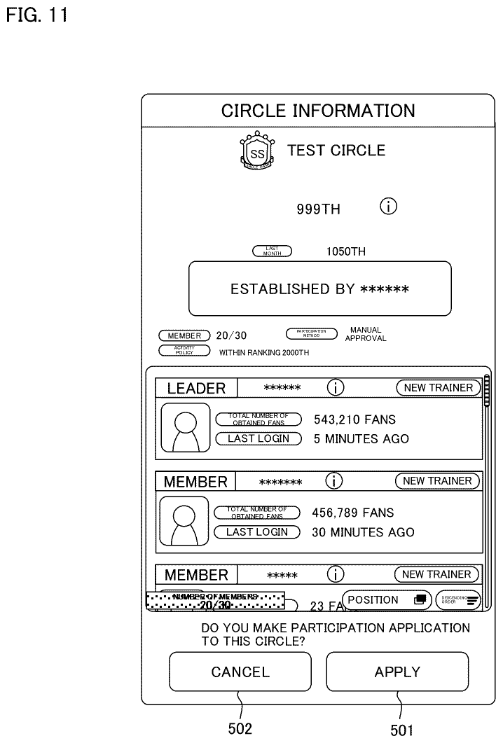

When another player who has viewed the posting to the external service related to the circle member recruiting performs a tap input with respect to the participation-application link 405 in the player terminal 40 thereof, the participation-application dialog of the circle corresponding to the participation-application link 405 is displayed, as shown in FIG. 11. Specifically, the game application is activated, and the server 20 searches the circle management database 52 for the circle ID corresponding to the participation-application link 405 and notifies the player terminal 40 of the circle information related to the circle corresponding to the participation-application link 405. When the notification is received from the server 20, the player terminal 40 opens the participation-application dialog to display the circle information obtained from the server 20.

In the participation-application dialog, an application button 501 and a cancel button 502 are provided. When a tap input is performed with respect to the application button 501, a participation application request including the circle ID of the circle to which the participation application is made is sent to the server 20. When the participation application request is received, the server 20 adds the player who has sent the participation application request, to a participation application list that is linked to the circle ID included in the participation application request, in the circle management database 52. When the leader of the circle to which the participation application is made activates the game application in the player terminal 40 and starts the circle function, the leader can confirm the player who has made the participation application, by performing a tap input with respect to the member approval button 254 in the circle menu dialog. When the leader performs an approval operation, a participation approval request including the player ID of the player of which participation in the circle has been approved and the circle ID of the circle of the leader is sent from the player terminal 40 of the leader to the server 20. When the participation approval request is received, the server 20 adds the player ID included in the participation approval request to the affiliated-player list that is linked to the circle ID included in the participation approval request in the circle management database 52, whereby affiliation of the new member is completed. Note that, in the case where the participation method of the circle to which the participation application is made is set to automatic approval, when a tap input is performed with respect to the application button 501, approval processing is performed in the server 20 after the participation application request is received, i.e., the player ID of the player who has sent the participation application request is added to the affiliated-player list that is linked to the circle ID included in the participation application request in the circle management database 52, whereby affiliation of the new member is completed. Furthermore, in the case where a tap input is performed with respect to the cancel button 502 in the participation-application dialog, the participation-application dialog is closed, and the main home screen of the game is displayed on the display unit 46.

Incidentally, in order for a player to make a participation application to a circle, it is necessary that the player is in a situation where the player can join the circle and that the receiving-side circle is also in a situation where a new member can be affiliated thereto. Thus, in the case where the participation-application dialog cannot be used by either the player who is going to make a participation application or the circle that is going to receive the participation application, the following processing is performed.

In the case where it has not yet been 24 hours since a player who uses the participation-application link 405 dissolves the circle or withdraws from the circle, the player is restricted from being affiliated to a new circle. In this case, although the participation-application dialog is displayed, the application button 501 is disabled, thus performing processing for disabling a participation application request from being sent, and the application button 501 is grayed out.

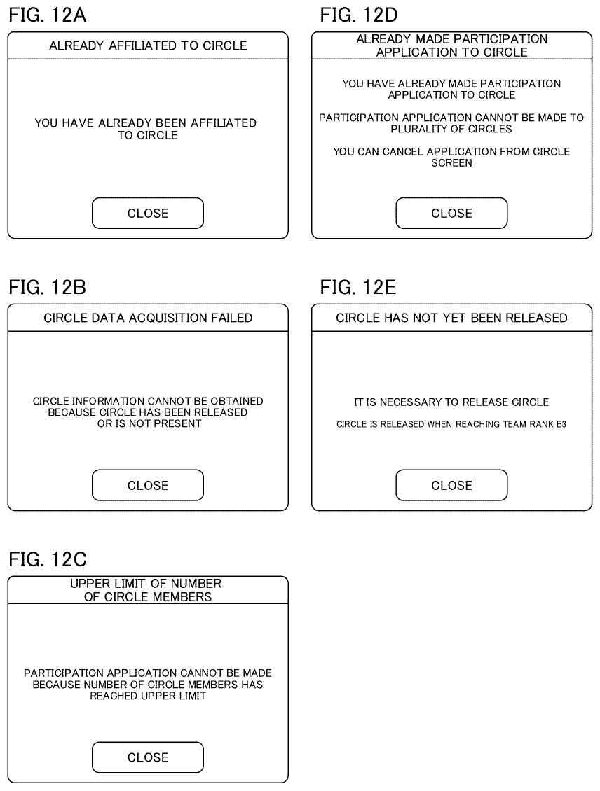

In the case where a player who uses the participation-application link 405 has already been affiliated to the circle, the participation-application dialog is not displayed, and processing for displaying an alert dialog for notifying that you have already been affiliated to the circle, as shown in FIG. 12A, is performed.

In the case where it is determined that the circle corresponding to the participation-application link 405 is not present in the circle management database 52 because the circle has been dissolved or because of another reason, processing for displaying an alert dialog for notifying that the circle information could not be obtained, as shown in FIG. 12B, is performed.

In the case where a new member cannot be affiliated to the circle corresponding to the participation-application link 405 because the circle has reached its capacity (30 members), processing for displaying an alert dialog for notifying that the number of players (the number of members) affiliated to the circle has reached its upper limit, as shown in FIG. 12C, is performed.

In the case where a player who uses the participation-application link 405 has already made a participation application to another circle, processing for displaying an alert dialog for notifying that you are now making a participation application to another circle, as shown in FIG. 12D, is performed.

In the case where a player who uses the participation-application link has not released the circle function, processing for displaying an alert dialog for notifying that you have not yet released the circle function, as shown in FIG. 12E, is performed.

In the above-described information processing system 10 of this embodiment, since post data that includes a circle card image linked to a circle and link information used to make a participation application to the circle and that can be used to be posted to an external service is created on the basis of a player's SNS share operation, the convenience of a circle recruitment activity using an external service is improved. Furthermore, in the information processing system 10 of this embodiment, since the post data includes link information used to make a participation application to the circle, the convenience is improved when another player who becomes interested in participating after reading the post to the external service makes a participation application to the circle.

In this embodiment, although an embodiment in which a URL address is stated as the participation-application link 405 in the post data has been adopted, it is also possible to adopt an embodiment in which link information related to participation application to the circle is embedded in the circle card image 301. In this case, another player who views the circle card image 301 posted to an external service can open the participation-application dialog for the circle by performing a tap input with respect to the circle card image 301.

In this embodiment, although an embodiment in which post data for an external service is output to a shared memory area in the storage device 47 of the player terminal 40 and is automatically input to the posting input form of the external service by using the external-service sharing function of the operating system of the player terminal 40 has been adopted, it is also possible to adopt an embodiment in which a clipboard is used as the output destination of the post data, and the player manually inputs the post data to the posting input form by performing a paste operation in the posting input form of the external service.

In this embodiment, although a configuration in which the external-service sharing function of the operating system of the player terminal 40 is used to assist in posting, to an external service, post data including a circle card image and link information used for making a participation application to the circle has been adopted, it is also possible to adopt a configuration in which post data can be immediately posted to an external service, on the basis of the fact that an SNS share operation is accepted in the circle card screen.

In this embodiment, although the right to edit the circle card image is given only to the leader, it is also possible to adopt a configuration in which the leader can individually give the right to edit the circle card image to a member who is affiliated to the circle.

An external service may be a bulletin board in a web site or an email, in addition to a social networking service (SNS).

When the content of edit of the circle card image 301 is saved in the card edit screen, the related information (the illustration-part related information, the text-part related information) and the circle setting information (the circle name, the activity policy, the participation method, etc.,) of the circle card image 301 are uploaded to the server 20 and are managed in the circle management database 52 while being linked to the circle ID. Thus, in the case where the circle card image 301 is displayed in the player terminal 40, the related information and the circle setting information of the circle card image 301, which are managed in the circle management database 52, are downloaded each time from the server 20 to the player terminal 40, and the circle card image 301 can be generated in the player terminal 40 on the basis of the downloaded information. Note that the related information and the circle setting information of the circle card image 301 may be downloaded to the player terminal 40 at the time of activation of the game application or may be downloaded to the player terminal 40 at the time of start of the circle function.

Furthermore, it is also possible to adopt a configuration in which the individual functions of the information processing system 10 are provided in another game. For example, the information processing system 10 is applicable to a game in which an in-game community of a circle, a guild, a clan, or the like is established, and players can participate in the in-game community and interact with one another, for example, to various kinds of games, e.g., sport games such as a baseball game and a soccer game, idol nurture games, love simulation games, card battle games, fighting games, action games, battle royale games, role-playing games, shooting games, etc.

What is claimed is:

1. A program for a game in which there is an in-game community in which a player can participate, the program causing a computer to function as:
a profile image editing unit that enables editing of a profile image including information of the in-game community; and
a post data creating unit that creates post data available to be posted to an external service,
wherein the post data creating unit creates, on the basis of a specific operation of a player, the post data including the profile image, which is linked to the in-game community to which the player is affiliated, and link information used to make a participation application to the in-game community.

2. A program according to claim 1,
wherein a member attribute is set for each player who is affiliated to the in-game community; and
the profile image editing unit gives a right to edit the profile image to a player of which the member attribute is set to a leader.

3. An information processing system for a game in which there is an in-game community in which a player can participate, the information processing system comprising:
a profile image editing unit that enables editing of a profile image including information of the in-game community; and
a post data creating unit that creates post data available to be posted to an external service,
wherein the post data creating unit creates, on the basis of a specific operation of a player, the post data including the profile image, which is linked to the in-game community to which the player is affiliated, and link information used to make a participation application to the in-game community.

4. An information processing method for a game in which there is an in-game community in which a player can participate, the information processing method causing a computer to execute:
a profile image editing step of enabling editing of a profile image including information of the in-game community; and
a post data creating step of creating post data available to be posted to an external service,
wherein, in the post data creating step, the post data is created on the basis of a specific operation of a player, the post data including the profile image, which is linked to the in-game community to which the player is affiliated, and link information used to make a participation application to the in-game community.
